(19) United States
(12) Patent Application Publication
(10) Pub. No.: US 2007/0201852 A1
(43) Pub. Date: Aug. 30, 2007

(54) Electronic Focusing Device And Method For Camera

(75) Inventor: Hsu-Ting Cheng, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Lite-On Technology Corp., Taipei (TW)

(21) Appl. No.: 11/382,919

(22) Filed: May 11, 2006

(30) Foreign Application Priority Data
Feb. 24, 2006 (TW) 095106443

(51) Int. Cl. G03B 13/34

(52) U.S. Cl. 396/133

(57) ABSTRACT

Disclosed is an electronic focusing device and method for a camera. A stick handle made of a radial magnetization magnet is provided for focus adjustment. One or two current-induced magnetization bodies are provided and one of which receives a current signal to provide a magnetic force. Through the magnetic force, the stick handle is caused to move, achieving the result of focus adjustment of the camera. In another embodiment, a piezo-electric device is connected to a friction member so as to move the stick handle contacted with the friction member in response to an applied voltage signal, also achieving the focus adjustment effect of the camera.

### FIELD OF THE INVENTION

The present invention relates to a focusing device for a camera, and more particularly to an electronic focusing device for a camera, particularly for a cellular phone camera.

### BACKGROUND OF THE INVENTION

For a proper acquisition of an object image by a user, a general camera is equipped with a focusing device, which is true also for the currently prevailing digital camera and cellular phone camera. Such conventionally used focusing device may be referred to FIG. 1. On the focusing device 10, a lens 11 and a stick handle 12 are connected externally to the lens 11. When the user moves the stick handle 12 on the lens 11 of the focusing device 10, a desired focus of the lens 11 can be obtained by the focusing device 10. At this time, the proper acquisition of the object image can be well achieved.

On the general and digital cameras, a step motor is used in the focusing mechanism to adjust the motion amount of the stick handle and thus the focus thereof. However, this is not the case with respect to the cellular phone camera since the huge step motor is hard to be placed into the cellular phone. Further, the stick handle is also not suitable to be mounted on the cellular phone since the portability of the cellular phone will be decreased owing to the presence of the stick handle. In addition, the outline of the cellular phone would be undesirably affected since the stick handle has to be mounted inside the cellular phone and penetrated through the housing covering the lens, requiring an opening formed on the housing. Furthermore, the stick handle has to be manually operated in adjusting the focus of the lens. All the mentioned issues impose an unfavorable image on the high quality camera.

To solve the problem that the focusing device of the cellular phone camera can only be operated manually, an electronic focusing device has been developed, which is shown in FIG. 2. In the electronic focusing device 20, a cone 21 for containing the lens (not shown) is wounded with a coil 22. When a current is applied on the coil 22, the focus of the lens becomes different from that when the current is absent. This focusing mechanism is called voice coil motor (VCM) based focusing mechanism or electromagnetic valve actuation mechanism. Generally, the focusing function includes a dual-mode focusing function and a continuous focusing function. In the cellular phone, since it is not the step motor that is used to move the stick handle, a resilient piece is required to achieve the continuous focusing function. Although the VCM based focusing mechanism may be operated non-manually, the wound coil increases the size and cross-sectional area of the cone. Thus, such focusing device is not suitable to be used in the cellular phone and other slight and compact devices.

In view of the above, there is a need to provide a cellular phone camera having an automatic focusing mechanism which is suitable to be adopted in the cellular phone. After a long intensive series of experiments and research, the inventor finally sets forth such an electronic focusing mechanism for the camera, particularly used for the cellular phone camera, which may effectively overcome the demerits existing in the prior art.

### SUMMARY OF THE INVENTION

In accordance with a aspect of the present invention, an electronic focusing device for a camera is disclosed, which comprises a cone having a lens therein and an outer surface, a stick handle being a radial magnetization magnet, connected to the outer surface of the cone and movable along an arc path having a first end and a second end, and an electroactivated motion mechanism mounted adjacent to the stick handle and moving the stick handle between the first end and the second end in response to a current signal.

In accordance with another aspect of the present application, an electronic focusing method for a camera having a stick handle is provided. The electronic focusing method comprises the step of activating the stick handle of the camera with one of a current signal and a voltage signal to move between a first focusing position and a second focusing position so as to achieve a focusing effect of the camera.

Other objects, advantages and efficacies of the present invention will be described in detail below taken from the preferred embodiments with reference to the accompanying drawings.

### BRIEF DESCRIPTION OF THE DRAWINGS

The foregoing summary as well as the following detailed description of the preferred embodiments are better understood when read in conjunction with the appended drawings. It is understood, however, that the invention is not limited to the specific methods and disclosed or illustrated. In the drawings:

FIG. 1 is a cross-sectional view of a conventional focusing device for a camera;

FIG. 2 is a top view of a conventional electronic focusing device for the camera;

FIG. 3 is a front view of an electronic focusing device for the camera according to a first embodiment of the present invention;

FIG. 4A is a schematic diagram illustrating a magnetic action between a stick handle made of a radial magnetization magnet and a magnetic body;

FIG. 4B is a schematic diagram illustrating a magnetic action between a stick handle made of a general magnet and the magnetic body;

FIG. 5 is a top view of the electronic focusing device for the camera according to a second embodiment of the present invention;

FIG. 6 is a cross-sectional view of the electronic focusing device for the camera according to a third embodiment of the present invention;

FIG. 7 is a cross-sectional view of the electronic focusing device for the camera according to a fourth embodiment of the present invention; and

FIG. 8 is a flowchart illustrating an electronic focusing method according to the present invention.

FIG. 9 is a flowchart of an electronic focusing method according to the present invention.

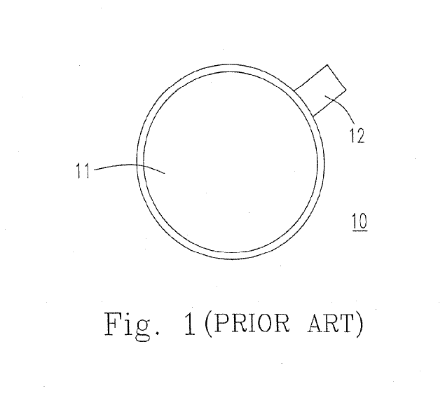

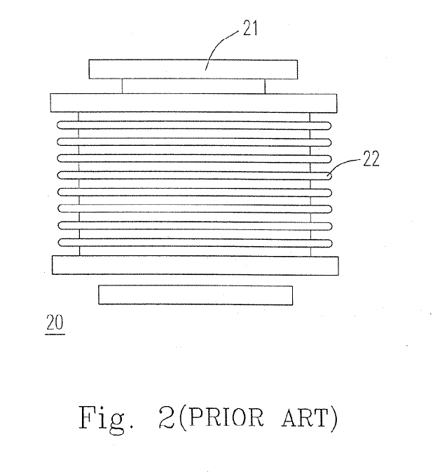

### DETAILED DESCRIPTION OF THE PREFERRED EMBODIMENT

The present invention discloses an electronic focusing device and method for a camera, particularly for a cellular phone camera, which will now be described more specifically with reference to the following embodiments.

It is to be noted that the following descriptions of preferred embodiments of this invention are presented herein for purposes of illustration and description only; it is not intended to be exhaustive or to be limited to the precise form disclosed.

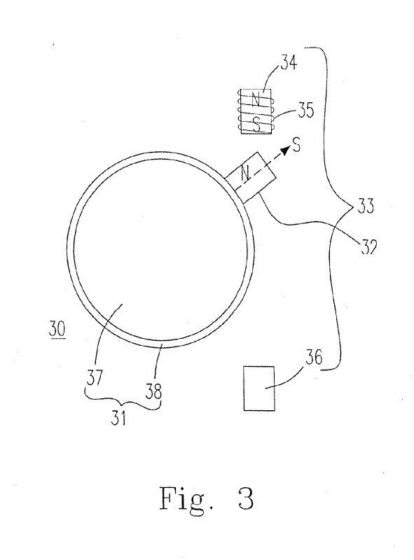

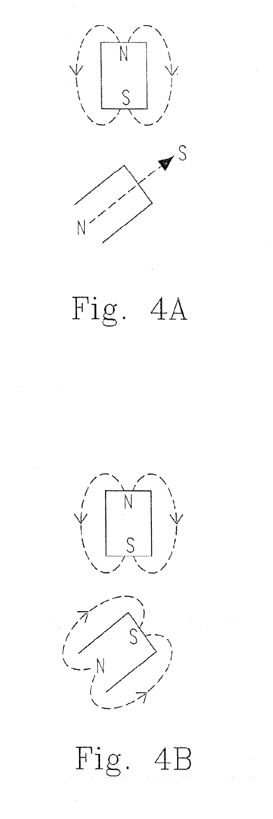

Referring to FIG. 3, a front view of the electronic focusing device for a camera according to a first embodiment of the present invention is shown therein. As shown, the electronic focusing device comprises a cone 31, a stick handle 32 and an electroactivated motion mechanism 33. The cone 31 has a lens and an outer surface covering thereon. The stick handle 32 is connected to the outer surface of the cone 31. The stick handle 32 is made of a radial magnetization magnet having radially arranged magnetic lines, which are different from the prior art. The electroactivated motion mechanism 33 comprises a current-induced magnetic body 34, a coil 35 and a stop piece 36. The coil 35 is wound on the current-induced magnetic body 34 so as to induce the current-induced magnetic body 34 to become magnetic in response to a current flown through the coil 35. The current-induced magnetic body 34 moves the stick handle 32 by means of a magnetic action existing therebetween from an original position to where the stop piece 36 stands and is thus fixed by the stop piece 36. Since the stick handle 32 is moved, a focus of the lens is varied correspondingly. The original position of the stick handle 32 is termed as a first focusing position while the position of the stick handle 32 at the stop piece 36 is termed as a second focusing position.

In the above, the stick handle 32 moves along a specific arc path with one end defined by the current-induced magnet body 34 and the other end defined by the stop piece 36, i.e. the first and second focusing positions of the stick handle 32. In operation, the user may click a key exclusive for the focusing function on a cellular phone with a camera having the electronic focusing function of the present invention so that the focus of the lens may be adjusted between the first and second focusing positions. Specifically, when the current signal is generated and flown through the coil 35, the current-induced magnetic body is induced to become magnetic. Thus, the stick handle is caused to move by the current-induced magnetic body by means of the magnetic action existing therebetween. The current-induced magnetic body 34 may be made of a soft magnetic material, such as an insulator or other materials capable of generating a significant magnetization when an external current is applied thereon.

As mentioned above, the stick handle 32 is made of the radial magnetization magnet, whose magnetic lines have the arrangement and directions making itself easier to be acted by the current-induced magnetic body 34 so as to move along a desired direction, as compared to a general magnet-made stick handle. In the case when the general magnet-made stick handle is used, the stick handle 32 is acted at more directions and thus only a reduced net action force is generated thereon. Accordingly, the radial magnetization magnet rather than the general magnet is used to form the stick handle 32 in the present invention for the sake of the motive result of the stick handle 32.

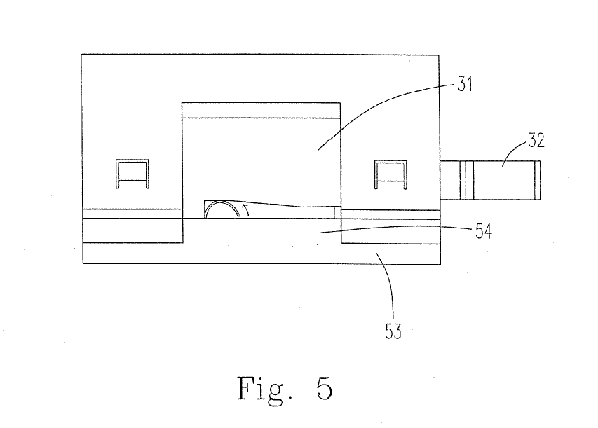

In addition, the electronic focusing device can also be provided with a continuous focusing function in addition to the above described dual-mode focusing function. To achieve this function, only a resilient piece is additionally required. The electronic focusing device having the resilient piece (taken here as a second embodiment) may be referred to in FIG. 5 in a cross-sectional form. As shown, the electronic focusing device 50 further has a base 53, disposed below the cone 31. On the cone 31, there is also the stick handle 32. The resilient piece 54 is disposed between the base 53 and the cone 31.

Referring concurrently to FIG. 3, when a relatively lower current signal is issued by the user by clicking the exclusive key on the cellular phone, a relatively lower magnet force is produced by the current-induced magnetic body 34 on the stick handle 32. Correspondingly, a smaller force is exerted on the cone 31. At this time, the resilient 54 produces a corresponding force on the other side of the cone 31 so that the cone 31 can be moved within a specific range corresponding to the range defined by the first and second focusing positions of the stick handle 32. The current signal has a plurality of levels so that the stick handle 32 can be moved to a plurality of focusing positions between the first and second focusing positions. As such, the continuous focusing function can be achieved with the use of the electronic focusing device.

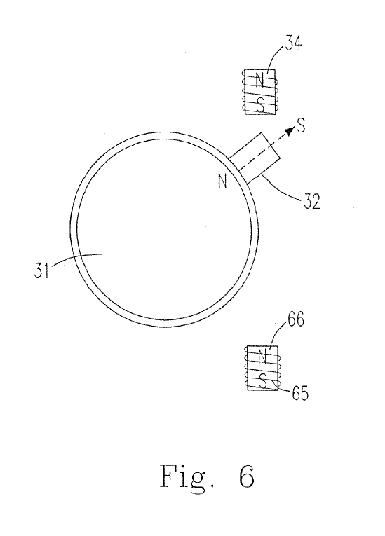

FIG. 6 depicts a cross-sectional view of the electronic focusing device according to a third embodiment of the present invention. As shown, the electronic focusing device 60 is identical to that in the first embodiment except that the above stop piece is replaced with another current-induced magnetic body 66 having another coil 65 wound thereon in this embodiment. In this case, only one of the current-induced magnetic bodies 34, 66 is applied with the current signal, will the dual-mode focusing function be obtained. When the resilient piece shown in FIG. 5 is used, taken as a fourth embodiment of the present invention, the continuous focusing function can be achieved as mentioned above. In this case, the resilient piece may be disposed between the stick handle 32 and the current-induced magnetic body 34 and/or between the stick handle 32 and the current-induced magnetic body 66. Similarly, the current signal has a plurality of levels and the stick handle 32 moves between the first and second focusing positions in response to the current signal of different levels.

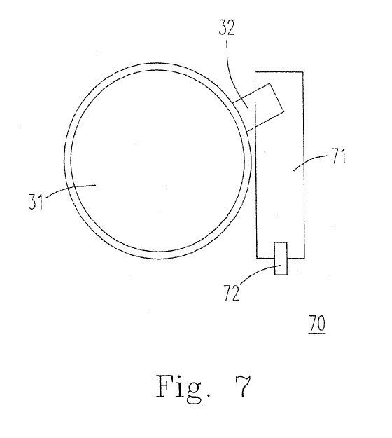

Referring to FIG. 7, a cross-sectional view of the electronic focusing device for the camera according to a fifth embodiment of the present invention is shown therein. As shown, the electronic focusing device 70 comprises a cone 31, a stick handle 32, a frictional member 71 and a piezo-electric device 72. The frictional member 71 is contacted with the stick handle 32 and disposed at an area outside the cone 31. The piezo-electric device 72 is fixedly connected to the frictional member 71 and has a specific volume. When the user clicks the exclusive key on the cellular phone, a voltage signal corresponding to the above mentioned current signal is received by the piezo-electric device 72 and the specific volume of the piezo-electric device 72 becomes a varied volume (e.g. an increased volume). At this time, the stick handle 32 is caused to move together with the frictional member 71 to a new focusing position. As such, the electronic focusing function is achieved since the stick handle 32 is moved to the new focusing position.

In the above, the current signal (the voltage signal) may be optionally removed after the stick handle 32 is moved to the new focusing position so that the purpose of power saving can be achieved. At this time, the stick handle 32 is maintained at the new focusing position by means of the friction existing between the stick handle 32 and the frictional member 71. The frictional member 71 may be a body having a gripping means so that the piezo-electric device 72 can be held and thus the piezo-electric device 72 can really push the frictional member 71 to move.

In the above, the stick handle is described as movable along a single direction. When the stick handle is to be moved along the other direction, an inverse voltage with respect to the above voltage signal should be provided so as to obtain an inversely varied volume with respect to the above varied volume (e.g. a decreased volume) of the piezo-electric device 72.

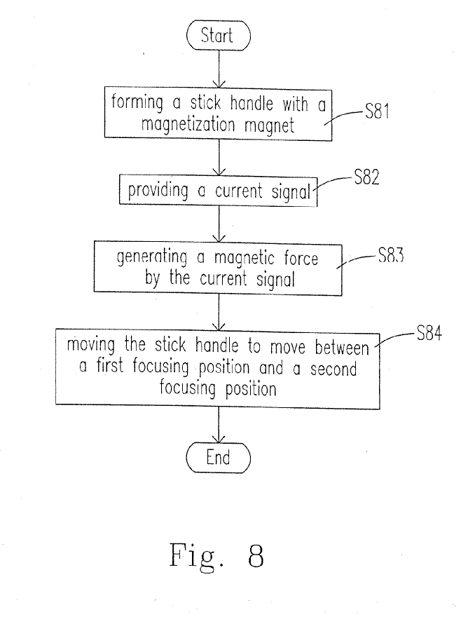

Referring to FIG. 8, a flowchart of an electronic focusing method according to a first embodiment of the present invention is shown therein, which can be performed on the above described electronic focusing device. The electronic focusing method comprises the following steps. At first, a stick handle is formed with a radial magnetization magnet (S81). Next, a current signal is provided (S82). Then, a magnetic force is generated by the current signal (S83). Finally, the stick handle is moved between a first focusing position and a second focusing position (S84).

In an embodiment, the current signal has a plurality of levels and the stick handle is moved to a plurality of focusing positions between the first and second focusing positions.

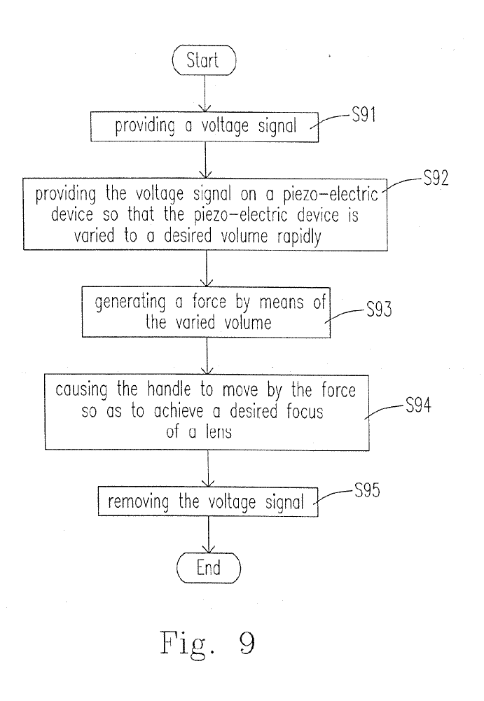

Referring to FIG. 9, a flowchart of an electronic focusing method according to a second embodiment of the present invention is shown therein, which can be performed on the above described electronic focusing device. The electronic focusing method comprises the following steps. At first, a voltage signal is provided (S91). Next, the voltage signal is provided on a piezo-electric device so that the piezo-electric device is varied to a desired volume rapidly (S92). Then, a force is generated by means of the varied volume (S93). Thereafter, a stick handle is caused to move by the force so as to achieve a desired focus of a lens (S94). Optionally, the voltage signal may be removed (S95). In an embodiment, the step S94 further comprises a step of providing a frictional member contacted with the stick handle and connected fixedly to the piezo-electric device so that the stick handle can be moved by the frictional member when the voltage signal is applied thereon. Correspondingly, when the voltage signal is removed, the stick handle can be maintained at place.

Certainly, the voltage signal may be maintained when the new focusing position of the stick handle has been reached. However, the voltage signal is preferably stopped for the power saving purpose. In addition, although the stick handle is described as movable along a single direction in the above, the stick handle may also be moved along the other direction. At this time, an inverse voltage with respect to the above voltage signal should be provided so as to obtain an inversely varied volume with respect to the above varied volume (e.g. a decreased volume) of the piezo-electric device.

In addition, since the method may be particularly performed on the above electronic focusing device, the preferred embodiments of the method may be referred to the preferred embodiments described for the electronic focusing device and will be omitted herein for the clarity purpose.

Since only the radial magnetization magnet, coil and current-induced magnetic body are involved in the electronic focusing device for the camera, the cost therefor is low. Further, since the stick handle is received in a housing of the cellular phone and the resilient piece is disposed below the cone, the volume of the electronic focusing device can be miniaturized and the quality of the lens is not reduced at the same time. Therefore, the electronic focusing device is considerably suitable to be utilized in the miniature cellular phone camera.

While the invention has been described in terms of what is presently considered to be the most practical and preferred embodiments, it is to be understood that the invention needs not be limited to the disclosed embodiments. For example, the radial magnetization magnet may be replaced with the general magnet although it is not as effective as the radial magnetization in causing the stick handle to move. On the contrary, it is intended to cover various modifications and similar arrangements included within the spirit and scope of the appended claims, which are to be accorded with the broadest interpretation so as to encompass all such modifications and similar structures.

What is claimed is:

1. An electronic focusing device for a camera, comprising:
a cone having lens therein and an outer surface;
a stick handle being a radial magnetization magnet, connected to the outer surface of the cone and movable along an arc path having a first end and a second end; and
an electroactivated motion mechanism mounted adjacent to the stick handle and driving the stick handle to move between the first end and the second end in response to a current signal.

2. The electronic focusing device as claimed in claim 1, wherein the electroactivated mechanism comprises:
a first current-induced magnetic body disposed on the first end of the arc path;
a first coil wound on the first current-induced magnetic body; and
a stop piece disposed on the second end of the arc path,
wherein the stick handle is moved to the second end when the current signal is flown through the first coil.

3. The electronic focusing device as claimed in claim 2, further comprising a resilient piece positioned between the stick handle and the stop piece.

4. The electronic focusing device as claimed in claim 2, wherein the stop piece is a second current-induced magnetic body with a second coil wound thereon, and the stick handle is moved to the second end of the arc path when the current signal flows through the second coil.

5. The electronic focusing device as claimed in claim 4, further comprising:
a base disposed below the cone; and
a resilient piece disposed between the base and the cone,
wherein the current signal has a level selected from a plurality of levels and the stick handle is moved between the first and second ends with the presence of the resilient piece in response to the current signal.

6. The electronic focusing device as claimed in claim 1, wherein the electroactivated motion mechanism comprises:
a frictional piece disposed outside the cone, contacted with the stick handle and providing a friction with respect to the stick handle so as to make the stick handle to move together therewith; and
a piezo-electric device connected to the frictional piece and having a first volume,
wherein the first volume of the piezo-electric device is changed rapidly to a second volume in response to a voltage signal corresponding to the current signal, so as to cause the frictional piece and the stick handle to move together therewith.

7. The electronic focusing device as claimed in claim 6, wherein the voltage signal is removed after being applied onto the piezo-electric device.

8. The electronic focusing device as claimed in claim 6, wherein the frictional piece is a body having a gripping piece for gripping the piezo-electric device.

9. The electronic focusing device as claimed in claim 7, wherein the voltage signal is positive when the stick handle moved toward the first end of the arc path, and a negative signal when the stick handle is moved towards the second end of the arc path.

10. The electronic focusing device as claimed in claim 7, wherein each of the current signal and the voltage signal corresponding thereto has a plurality of levels so as to enable the piezo-electric device to have a plurality of volumes.

11. The electronic focusing device as claimed in claim 1, wherein the camera is a cellular phone camera.

12. An electronic focusing method for a camera having a stick handle comprising the step of activating the stick handle of the camera to move between a first focusing position and a second focusing position by either a current signal or a voltage signal so as to achieve a focusing result of the camera.

13. The electronic focusing method as claimed in claim 12, wherein the step of activating comprises the steps of:
forming the stick handle with a radial magnetization magnet; and
producing a magnetic force with the current signal so as to move the stick handle.

14. The electronic focusing method as claimed in claim 13, wherein the step of producing the magnetic force comprises the step of:
generating the magnetic force on a current-induced magnetic body of the camera.

15. The electronic focusing method as claimed in claim 14, wherein the current signal has a plurality of levels and the stick handle is moved to a plurality of focusing positions between the first and second focusing positions.

16. The electronic focusing method as claimed in claim 14, wherein the step of activating comprises the step of:
bringing the stick handle to move by generating a force by using the voltage signal.

17. The electronic focusing method as claimed in claim 16, wherein the step of bringing comprises the steps of:
providing a piezo-electric device;
obtaining a changed volume of the piezo-electric device; and
causing the stick handle to move by using the changed volume of the piezo-electric device.

18. The electronic focusing method as claimed in claim 17, further comprising a step of stopping the voltage signal after the step of producing.

19. The electronic focusing method as claimed in claim 17, wherein the voltage signal has a plurality of levels so as to enable the piezo-electric device to have a plurality of volumes.

20. The electronic focusing method as claimed in claim 17, wherein the step of causing further comprises the step of:
providing a frictional piece contacted with the piezo-electric device and having a friction with respect to the piezo-electric device so as to make the stick handle to move together therewith.

21. The electronic focusing method as claimed in claim 17, wherein the voltage signal is a positive signal when the stick handle is moved towards the first focusing position, and a negative signal when the stick handle is moved towards the second focusing position.

22. The electronic focusing method as claimed in claim 12, wherein the camera is a cellular phone camera.

23. An electronic focusing device, comprising:
a lens;
a handle connected to the lens and movable along an arc path having a first end and a second end; and
a motion mechanism mounted adjacent to the handle and moving the handle between the first end and the second end when the motion mechanism is enabled.
